(19) United States
(12) Patent Application Publication
(10) Pub. No.: US 2014/0285491 A1
(43) Pub. Date: Sep. 25, 2014

(54) DISPLAY CONTROL DEVICE

(71) Applicants: OMRON HEALTHCARE Co., Ltd., Muko-shi, Kyoto (JP); OMRON Corporation, Shimogyo-ku, Kyoto-shi, Kyoto (JP)

(72) Inventors: Yutaka Otsubo, Kyoto (JP); Ai Kanazawa, Kyoto (JP); Tetsuya Sato, Kyoto (JP); Eriko Kan, Kyoto (JP); Naoki Tsuchiya, Kyoto (JP)

(21) Appl. No.: 14/360,417

(22) PCT Filed: Nov. 5, 2012
(86) PCT No.: PCT/JP2012/078605

§ 371 Date: May 23, 2014

(30) Foreign Application Priority Data
Nov. 24, 2011 (JP) 2011-256418

(51) Int. Cl. G06T 11/20

(52) U.S. Cl. CPC G06T 11/206
USPC 345/440

(57) ABSTRACT

A display control device that provides a display that supports and empowers body weight reduction includes a receiver configured to receive measurement data and zone data, the measurement data including a measured physical status value of a user and a corresponding measurement date, the zone data representing an upper limit value and a lower limit value of a physical status value for target achievement of the weight reduction, and a display unit configured to display an image. The display unit is configured to display a graph and a zone image in a same screen in association with each other, the graph representing a time-series change in the measured physical status value from the measurement data, the zone image representing a time-series change in the upper and lower limit values from the zone data.

### BACKGROUND OF THE INVENTION

1. Field of the Invention

The present invention relates to a display control device, in particular, a display control device that displays a time-series change in physical status information such as a measured body weight in the form of a graph.

2. Description of the Related Art

In order to allow a user to manage his/her body weight by himself/herself for the purpose of body weight reduction or the like, there is proposed a method of supporting body weight reduction using a program operating on a mobile phone, a smart phone, or the like.

For example, a diet program is provided which supports a diet on a smart phone by recording a body weight, calories, menstrual days, and the like, for the purpose of self-management.

Meanwhile, Japanese Patent Laying-Open No. 2008-220818 provides a method of managing a body weight based on whether or not the body weight falls within the range of a pacing line generated for body weight management.

In Japanese Patent Laying-Open No. 2008-117043, a diet plan and an evaluation are managed using a calendar. The evaluation is indicated by icons representing “Achieved”, “Mediocre”, and “Failed”.

Meanwhile, although Japanese Patent Laying-Open No. 2008-276670 and Japanese Patent Laying-Open No. 2010-167043 do not provide a program for body weight control, each of Japanese Patent Laying-Open No. 2008-276670 and Japanese Patent Laying-Open No. 2010-167043 supports health management for women by wirelessly transmitting measurement data from a basal body thermometer to a mobile phone and displaying a basal body temperature and a physical phase (a low temperature phase, an ovulatory phase, a hyperthermic phase, or the like).

However, in Japanese Patent Laying-Open No. 2008-220818 and Japanese Patent Laying-Open No. 2008-117043, it is impossible to visually check whether or not the measured body weights are changing in a zone of body weight values for achieving a target. This makes it difficult for the user to maintain motivation for body weight management.

In Japanese Patent Laying-Open No. 2008-276670 and Japanese Patent Laying-Open No. 2010-167043, variations in a physical phase of an individual can be checked by the user but are not applied to the body weight management. Hence, even though the user is informed of her physical phase, she is not notified of whether or not the measured body weights are changing within the zone of body weight values for achieving a target. This makes it difficult for the user to maintain motivation for body weight management.

### SUMMARY OF THE INVENTION

Accordingly, preferred embodiments of the present invention provide a display control device that controls display of information such that a user is empowered to maintain motivation for physical status management.

A display control device according to a preferred embodiment of the present invention is a display control device that displays a screen that supports body weight reduction for a user, and includes a receiver configured to receive measurement data and zone data, the measurement data including a measured physical status value of the user and a corresponding measurement date, the zone data representing an upper limit value and a lower limit value of a physical status value for target achievement of the body weight reduction, and a display device configured to display an image in the screen. The display device is configured to display a graph and a zone image in a same screen in association with each other, the graph representing a time-series change in the measured physical status value based on the measurement data received, the zone image representing a time-series change in the upper limit value and lower limit value based on the zone data received. The zone data is generated preferably based on a measured physical status value at a start of the body weight reduction, a target physical status value, and a predetermined calculation formula.

According to various preferred embodiments of the present invention, information is displayed such that a user is empowered to maintain motivation for physical status management through body weight reduction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic configuration diagram of a health management supporting system according to a preferred embodiment of the present invention.

FIG. 2 is a hardware configuration diagram of a server device according to a preferred embodiment of the present invention.

FIG. 3 is a hardware configuration diagram of a smart phone according to a preferred embodiment of the present invention.

FIG. 4 is a functional configuration diagram of the smart phone according to a preferred embodiment of the present invention.

FIG. 5 is a functional configuration diagram of the server device according to a preferred embodiment of the present invention.

FIG. 6 shows personal information according to a preferred embodiment of the present invention.

FIG. 7 shows measurement information according to a preferred embodiment of the present invention.

FIG. 8 shows target information according to a preferred embodiment of the present invention.

FIG. 9 illustrates a portion of a message logic table according to a preferred embodiment of the present invention.

FIG. 10 illustrates a calculation method for a target zone according to a preferred embodiment of the present invention.

FIG. 11 is a process flowchart for a health management supporting system according to a preferred embodiment of the present invention.

FIG. 12 is a process flowchart for the health management supporting system according to a preferred embodiment of the present invention.

FIG. 13 shows one exemplary communication data packet according to a preferred embodiment of the present invention.

FIG. 14 shows an exemplary display screen of the smart phone according to a preferred embodiment of the present invention.

FIG. 15 shows an exemplary display screen of the smart phone according to a preferred embodiment of the present invention.

FIG. 16 shows an exemplary display screen of the smart phone according to a preferred embodiment of the present invention.

FIG. 17 shows an exemplary display screen of the smart phone according to a preferred embodiment of the present invention.

FIG. 18 shows an exemplary display screen of the smart phone according to a preferred embodiment of the present invention.

FIG. 19 shows an exemplary display screen of the smart phone according to a preferred embodiment of the present invention.

FIG. 20 shows an exemplary display screen of the smart phone according to a preferred embodiment of the present invention.

FIG. 21 shows an exemplary display screen of the smart phone according to a preferred embodiment of the present invention.

FIG. 22 shows an exemplary display screen of the smart phone according to a preferred embodiment of the present invention.

FIG. 23 shows an exemplary display screen of the smart phone according to a preferred embodiment of the present invention.

FIG. 24 shows an exemplary display screen of the smart phone according to a preferred embodiment of the present invention.

FIG. 25 shows an exemplary display screen of the smart phone according to a preferred embodiment of the present invention.

FIG. 26 shows an exemplary display screen of the smart phone according to a preferred embodiment of the present invention.

### DETAILED DESCRIPTION OF THE PREFERRED EMBODIMENTS

The following describes preferred embodiments of the present invention with reference to figures. It should be noted that the same reference characters in the figures indicate the same or corresponding portions.

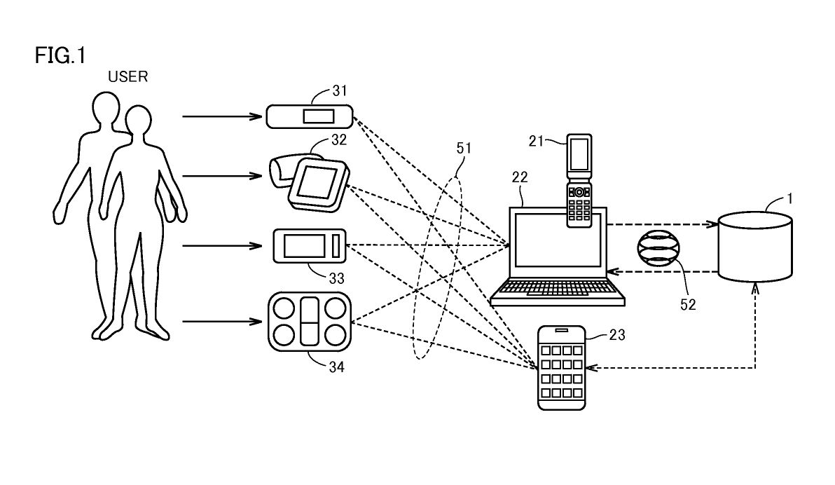

FIG. 1 shows a schematic configuration of a health management supporting system according to a preferred embodiment of the present invention. The health management supporting system according to the present preferred embodiment provides a function of managing a user's physical status (such as a body fat amount, a skeletal muscle ratio, or a body weight, for example) information. Described here is a “diet function”, which is a function for the user's body weight management, more particularly, a body weight management function for body weight reduction, for example.

Referring to FIG. 1, the health management supporting system preferably includes health instruments used by the user to measure and collect the user's physical status information to understand a life pattern, a physical condition, and a health condition; information terminals serving as user terminals to communicate with the health instruments; a server device 1 corresponding to a health management supporting device and communicating with the information terminals; and communication paths (communication lines) 51 and 52 configured to connect the instruments/devices to one another for communication. Examples of the health instrument preferably include an activity amount meter 33, such as a pedometer, and a sleep meter 31 each configured to measure a life pattern; and a body weight/body composition meter 34 and a blood pressure meter 32 each configured to measure information enabling understanding a body condition and a health condition. The types of the health instruments are not limited to those described above and may include any suitable health instrument.

It should be noted that information may be exchanged between the instruments/devices via a storage medium instead of communication paths 51, 52, for example.

Communication path 51 configured to connect a health instrument and an information terminal to each other includes a wired or wireless communication path. Examples of the wireless communication path include a short-range wireless communication path in compliance with the BT: Bluetooth® standard; and a contactless communication path in compliance with the FeliCa® standard. Communication path 52 configured to connect server device 1 and an information terminal to each other includes various types of networks such as the Internet.

It is assumed that a display control device according to the present preferred embodiment is provided in an information terminal. Examples of the information terminal include a mobile or stationary computers having a communication function, such as a mobile phone terminal 21, a PDA (Personal Digital Assistant), a smart phone 23, and a personal computer 22. The type of the information terminal is not limited to these, as long as the information terminal has a function of communicating with server device 1 and a function of communicating with the health instrument. For ease of description, it is illustrated herein that the information terminal preferably is a smart phone 23, for example, but the information terminal is not limited to this.

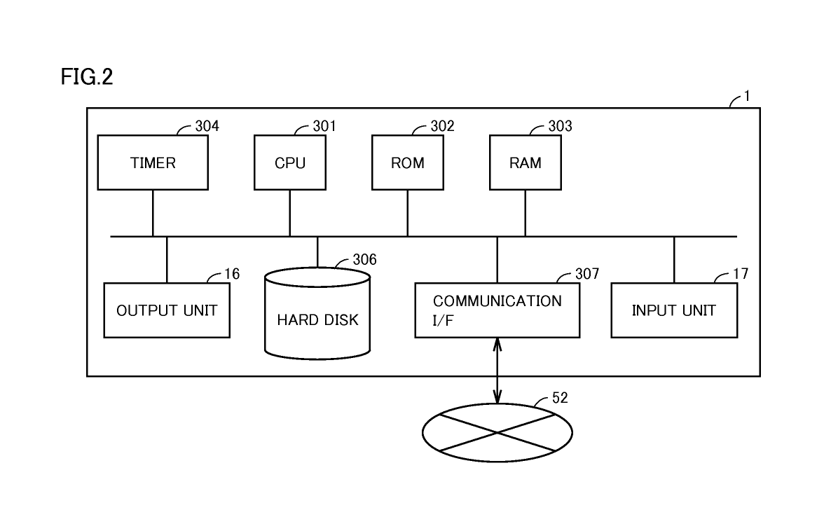

FIG. 2 shows a hardware configuration of server device 1. Server device 1 preferably includes a CPU (Central Processing Unit) 301 configured to control server device 1; a ROM (Read Only Memory) 302 having a program and data stored therein in advance; a RAM (Random Access Memory) 303 configured to store various types of data therein; a timer 304; a hard disk 306; a communication I/F (Interface) 307 configured to connect communication path 52 and server device 1 to each other; an output unit 16; and an input unit 17. Output unit 16 preferably includes a display unit, a printing unit, an audio output unit, and the like. The input unit preferably includes a keyboard, a pointing device such as a mouse, and the like.

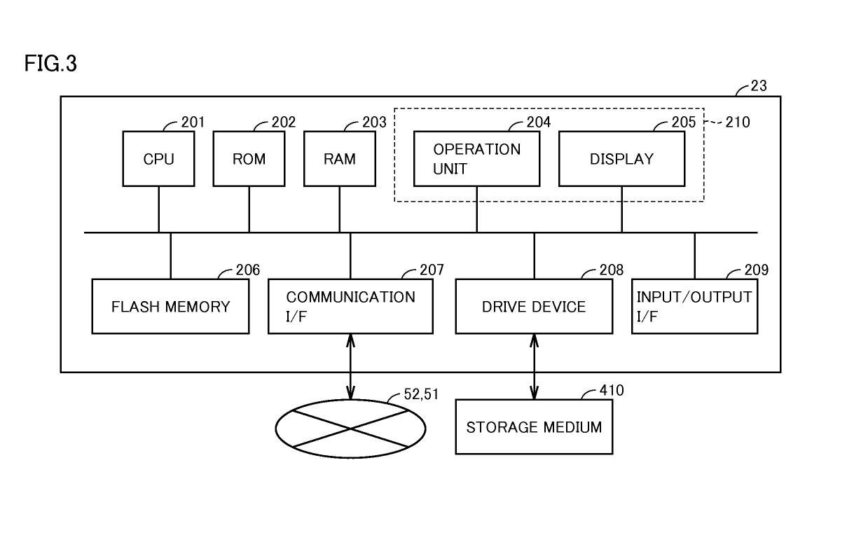

FIG. 3 shows a hardware configuration of smart phone 23. Smart phone 23 preferably includes a CPU (Central Processing Unit) 201 configured to control the device; a ROM (Read Only Memory) 202 having a program and data stored therein in advance; a RAM (Random Access Memory) 203 configured to store various types of data therein; an operation unit 204 configured to receive an operation to input the user's instruction and various types of information; a display 205 including liquid crystal or the like to display information; a nonvolatile memory such as a flash memory 206; a communication I/F (Interface) 207 connected to communication path 51 (52); a drive device 208 configured to write and read data in and from storage medium 410; and an input/output I/F (Interface) 209 configured to exchange data with the health instrument.

Smart phone 23 preferably includes a touch panel 210 obtained by integrally combining display 205 with operation unit 204 serving as a locator device such as a touchpad. The user can provide an instruction to smart phone 23 by operating (touching, for example) a displayed image on the screen of display 205.

In the present preferred embodiment, it is assumed that the user measures a body weight everyday at a morning time and an evening time using body weight/body composition meter 34. During the measurement of body weight, a body composition such as body fat is also measured. Here, it is assumed that the body weight is measured twice a day, but may be measured once a day, for example.

For the measurement of body weight, the term “morning time” is intended to indicate a time zone of, for example, 4:00 a.m. to noon (12 o'clock in the daytime), whereas the term “evening time” is intended to indicate a time zone of, for example, 7:00 p.m. to 2:00 a.m. A term “morning body weight” is intended to indicate a body weight measured at the morning time, whereas a term “evening body weight” is intended to indicate a body weight measured at the evening time. In the present preferred embodiment, it is assumed that measurement of body weight is performed at a timing closer to a wake-up time in a day and measurement of body weight is performed at a timing closer to a bedtime in the day. For ease of description, it is assumed that the body weight (evening body weight) is measured just before going to bed and the body weight (morning body weight) is measured just after waking up. Further, a term “nighttime reduced body weight” is intended to indicate a body weight reduced mainly by basal metabolism during a period of time from the time of going to bed to the time of waking up.

Body weight/body composition meter 34 stores measurement data in its internal memory every day. The measurement data includes the “morning body weight”, the “evening body weight”, and the measurement date thereof.

In the present preferred embodiment, a pedometer preferably attached to the user's body is illustrated as activity amount meter 33, but activity amount meter 33 is not limited to the pedometer. In other words, activity amount meter 33 may be a device having a function of measuring an activity amount in exercise or living activity (such as vacuuming with the use of a cleaner, carrying a baggage, cooking, or the like).

In activity amount meter 33, an acceleration sensor preferably is provided. The acceleration sensor detects acceleration applied to activity amount meter 33. The detected acceleration is derived as a voltage signal. Activity amount meter 33 preferably includes an MPU (Micro Processing Unit) (not shown) that processes an output signal from the acceleration sensor. For example, a process is performed to count one step whenever an acceleration equal to or more than a threshold value is detected based on signals sequentially output from the acceleration sensor.

As a measurement operation, the MPU calculates exercise intensity (unit: METs (Medical Evangelism Training & Strategies)) per unit time, which is a predetermined time interval (for example, an interval of about 20 seconds or the like) defined in advance. The calculation is performed using acceleration data measured based on the acceleration signal received from the acceleration sensor. The exercise intensity can be calculated using a known method, specifically, a method disclosed in Japanese Patent Laying-Open No. 2009-28312 by the Applicant, for example.

The exercise intensity is an index representing intensity of physical activity and depending on a pitch of walking (the number of steps per unit time) and a previously input body height of the user. For example, an exercise intensity in a rest state corresponds to 1 METs, an exercise intensity in a normal walking state (4 km/hour) corresponds to 3 METs, an exercise intensity when vacuuming with the use of a cleaner corresponds to 3.5 METs, an exercise intensity when jogging corresponds to 7 METs (Exercise and Physical Activity Reference for Health Promotion “EPAR 2006” (Ministry of Health, Labor and Welfare)).

Here, calorie consumption resulting from exercise preferably is calculated from the following formula: calorie consumption (kcal)=exercise intensity (METs)×body weight×exercise duration (h)×1.05 (Exercise and Physical Activity Reference for Health Promotion “EPAR 2006” provided by the Ministry of Health, Labor and Welfare). The MPU calculates calories to be consumed per day by the exercise, and adds a basal metabolic rate (kcal/day) to the calculated exercise-related calorie consumption, thus calculating the total calorie consumption of the user. It should be noted that the basal metabolic rate can be calculated in accordance with a known calculation formula using the user's age, sex, body weight, and body height.

Activity amount meter 33 stores measurement data in its internal memory every day. The measurement data includes the “total calorie consumption” and the measurement date thereof.

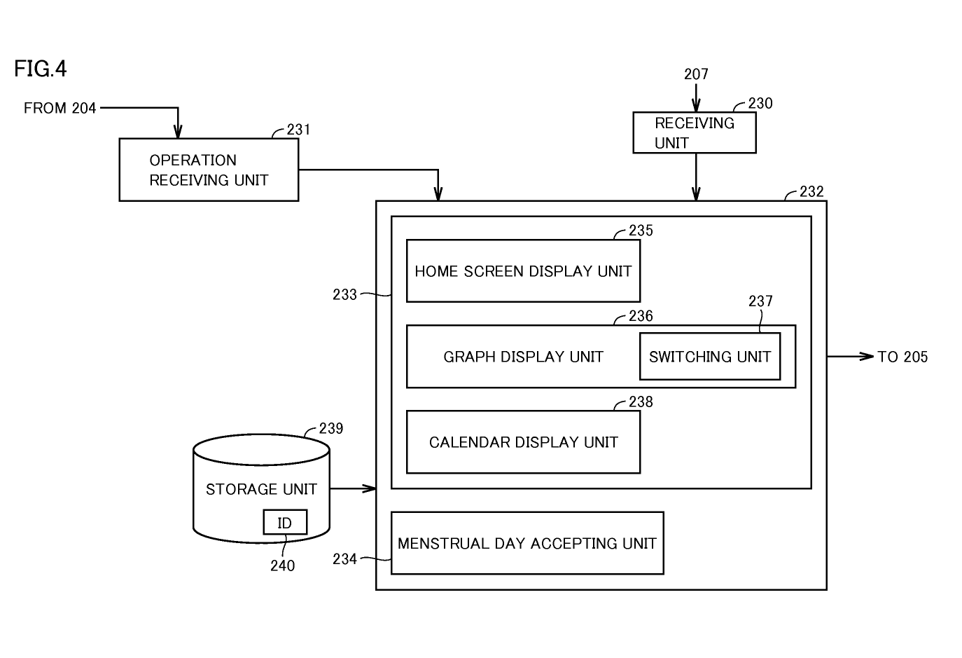

Referring to FIG. 4, the following describes a functional configuration of smart phone 23. Smart phone 23 preferably includes a control unit 232 corresponding to CPU 201; an operation receiving unit 231 configured to receive the user's operation via operation unit 204; a storage unit 239 corresponding to ROM 202, RAM 203, flash memory 206, storage medium 410, and the like; and a receiving unit 230 configured to receive data, which is transmitted from server device 1, via communication I/F 207.

Control unit 232 preferably includes a display control unit 233 configured to display an image on display 205; and a menstrual day accepting unit 234 configured to accept menstrual day information about the user.

Display control unit 233 includes a home screen display unit 235, a graph display unit 236, and a calendar display unit 238. Graph display unit 236 preferably includes a switching unit 237 configured to switch between display manners of a graph.

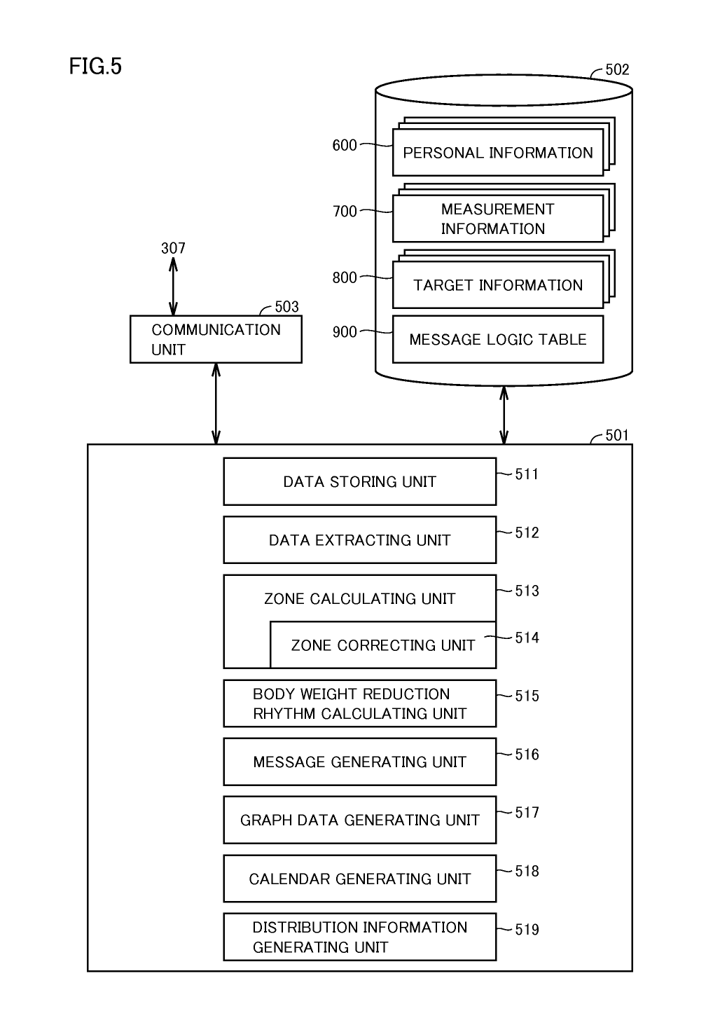

Referring to FIG. 5, the following describes a functional configuration of server device 1. Referring to FIG. 5, server device 1 includes a control unit 501 corresponding to CPU 301; a storage unit 502 corresponding to ROM 302, RAM 303, and hard disk 306; a communication unit 503 configured to perform a communication process via communication I/F 307.

Control unit 501 preferably includes a data storing unit 511 configured to store data and information in storage unit 502; a data extracting unit 512 configured to read data and information from storage unit 502; a zone calculating unit 513 configured to calculate a zone representing upper limit value and lower limit value of the body weight value for target achievement; a body weight reduction rhythm calculating unit 515 configured to calculate a period suitable for body weight reduction based on a menstrual period preferably according to the Ogino method; a message generating unit 516; a graph data generating unit 517; a calendar generating unit 518; and a distribution information generating unit 519 configured to generate information to be distributed to smart phone 23 of the user. Zone calculating unit 513 preferably includes a zone correcting unit 514 described below.

Stored in storage unit 502 preferably are personal information 600 regarding each user for the “diet” function provided by server device 1; measurement information 700 of each user; target information 800 indicating a target of each user for body weight reduction; and a message logic table 900, which is referenced to generate a message to be displayed to the user.

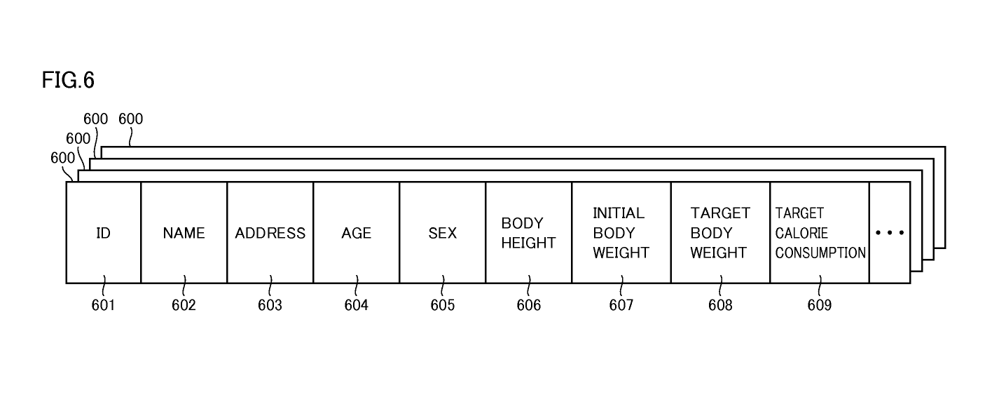

FIG. 6 illustrates personal information 600. Personal information 600 of each user preferably includes data of an ID (Identifier) 601 that identifies personal information 600; a name 602 serving as an identifier of the user, for example; an address 603 for communication with smart phone 23 of the user; an age 604 of the user; a sex 605 of the user; a body height 606 of the user; an initial body weight 607 at a start of body weight reduction; a target body weight 608; target calorie consumption 609 per day; and the like. It should be noted that personal information 600 may include a body weight reduction period or body weight reduction end day set by the user for target achievement. In the present preferred embodiment, for ease of description, the day on which personal information 600 is stored in storage unit 502 is determined as the body weight reduction start day, and the body weight reduction period preferably is determined as a several month period from the start day.

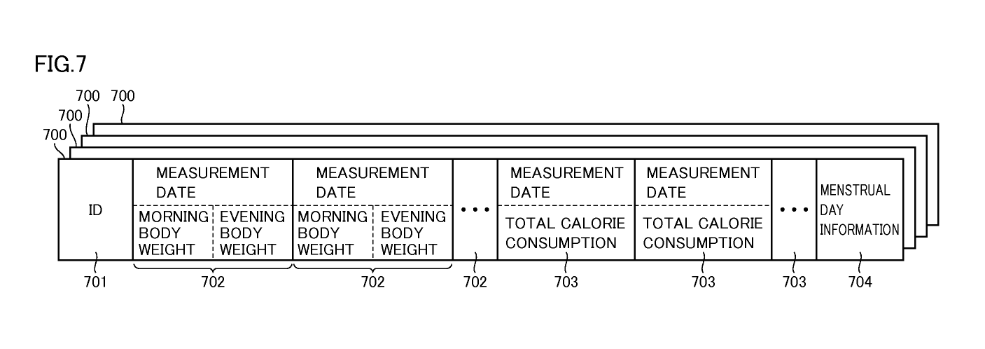

FIG. 7 illustrates measurement information 700. Measurement information 700 of each user preferably includes an ID (Identifier) 701 that identifies measurement information 700; one or more pieces of measured body weight data 702; one or more pieces of measured calorie consumption data 703; and menstrual day information 704.

Measured body weight data 702 includes a measured morning body weight, a measured evening body weight, and a measurement date thereof. Measured calorie consumption data 703 includes measured total calorie consumption per day, and a measurement date thereof.

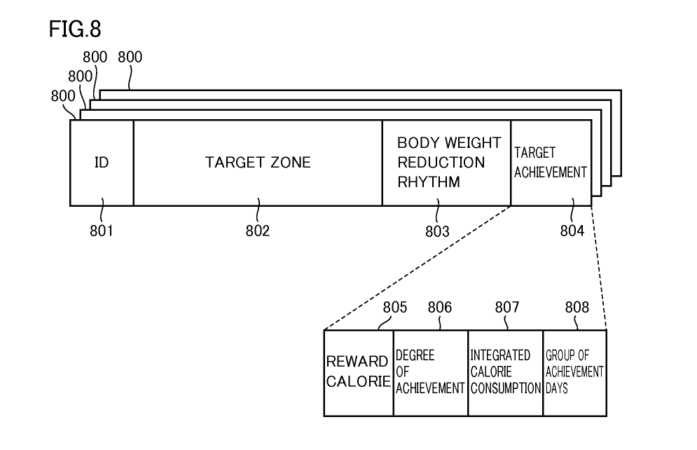

FIG. 8 illustrates target information 800. Target information 800 of each user include data of an ID (Identifier) 801 that identifies target information 800, a target zone 802, body weight reduction rhythm 803, and target achievement 804. Detailed data of target achievement 804 will be described later.

Each of IDs 601, 701, and 801 includes a portion including an identifier, which is based on, for example, the name identifying the user. Hence, personal information 600, measurement information 700, and target information 800 of the same user can be searched for from storage unit 502 using IDs 601, 701, and 801.

It should be noted that only when the user is female, menstrual day information 704 is registered in corresponding measurement information 700 and the data of body weight reduction rhythm 803 is registered in target information 800.

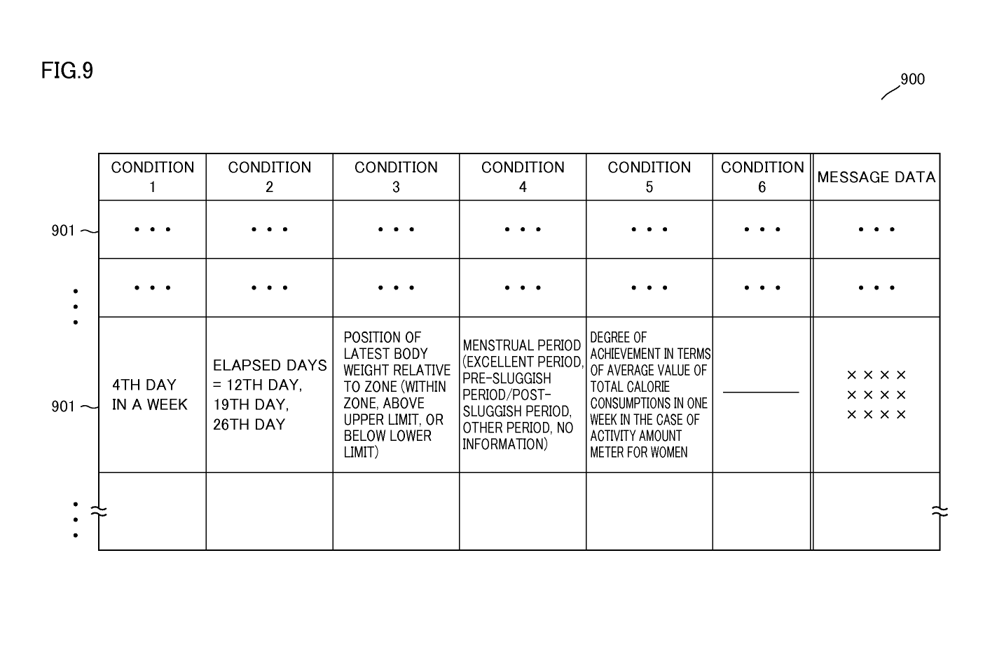

FIG. 9 illustrates a portion of message logic table 900. Referring to FIG. 9, a plurality of sets of conditions 901 used to generate a message to be displayed to the user for body weight management are registered in advance in message logic table 900. Each of the sets of conditions 901 preferably includes a combination of conditions 1 to 6; and message data indicating a message to be output when the combination of conditions is established.

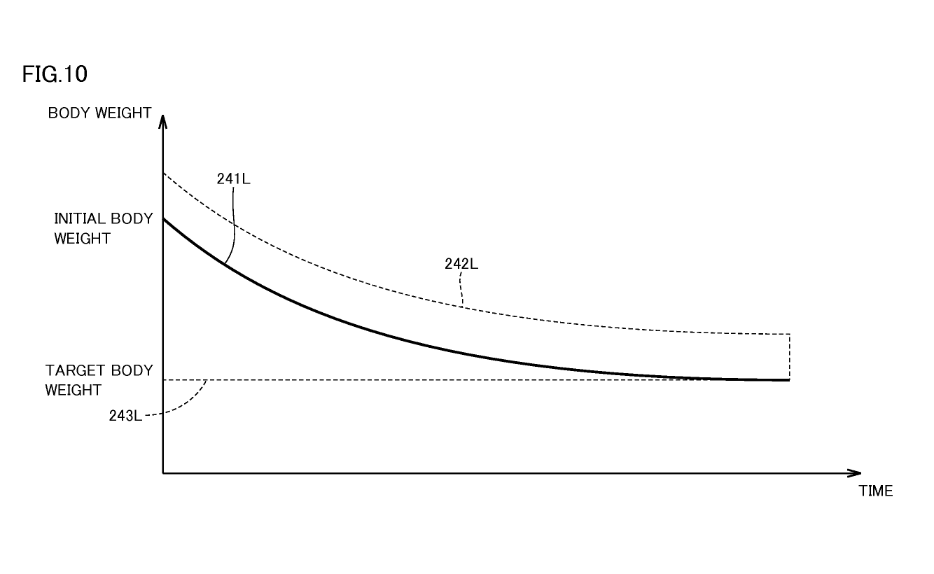

FIG. 10 shows a graph that illustrates a method of calculating target zone 802 by zone calculating unit 513. The vertical axis of the graph represents the body weight, whereas the horizontal axis represents elapsed time from the start of the body weight reduction. The graph shows a lower limit line 241L, an upper limit line 242L, and a target line 243L. Lower limit line 241L and upper limit line 242L are lines used to determine an upper limit value and a lower limit value defining a permissible range of variation of measured body weights during the body weight reduction period.

In the present preferred embodiment, zone calculating unit 513 determines a formula for lower limit line 241L using data of cases of body weight reduction that have succeeded, and determines a formula for upper limit line 242L using the formula for lower limit line 241L. It should be noted that target line 243L of FIG. 10 represents a linear expression for the target body weight.

First, zone calculating unit 513 determines coefficients a, b, c in the following formula for lower limit line 241L: LB=initial body weight 607×(a×exp(bx)+c)/100). Coefficients a, b, c are determined in accordance with a predetermined calculation formula set such that a body weight reduction ratio 90 days after the start of the body weight reduction is converged to be about 1.4 times as large as a body weight reduction ratio 30 days after the start thereof, for example.

Here, coefficient b is derived from sampling data obtained by empirically sampling morning body weight data of cases of body weight reduction having succeeded at a target body weight reduction ratio.

It should be noted that the target body weight reduction ratio is preferably calculated in accordance with the following formula: “target body weight reduction ratio”=((initial body weight 607−target body weight 608)/initial body weight 607)×100. In the present preferred embodiment, in the case where the user sets target body weight 608, it is preferable to satisfy 0%≦the target body weight reduction ratio<4%, for example. In this way, excessive body weight reduction is prevented.

Formula LU for upper limit line 242L is determined as (LU=LB+(1.5×initial body weight/100)) by translating lower limit line 241L upward by about 1.5% in parallel with initial body weight 607.

Upper limit line 242L provides a permissible range for body weight increase (upper limit value), and is represented by a formula obtained by sampling and verifying evening body weight data of the cases of body weight reduction having succeeded at the target body weight reduction ratio.

When the weight reduction is started, zone calculating unit 513 calculates target zone 802 including the formulas for lower limit line 241L and upper limit line 242L (target line 243L) as described above, and registers it in target information 800 of the user.

Further, zone calculating unit 513 preferably includes zone correcting unit 514 configured to correct target zone 802. Three days after the start of the body weight reduction, zone correcting unit 514 calculates an average value of the morning body weights in the three days, and performs calculation again based on Formulas LB and LU using the calculated average value as the “initial body weight”, for example. Then, zone correcting unit 514 overwrites (updates) target zone 802 of target information 800 using the calculated value. In this way, target zone 802 is corrected using the actually measured body weights.

It should be noted that target zone 802 preferably is corrected three days after the start, but may be corrected regularly (for example, every three days) after the correction, for example. Further, the average value of the morning body weights in the three days is preferably used, but another representative value (such as a mode or a median) may be used instead of the average value, for example.

Based on menstrual day information 704 of measurement information 700, body weight reduction rhythm calculating unit 515 calculates a menstrual period of the user, and calculates, based on the menstrual period, a period (hereinafter, referred to as “sluggish period”) unsuitable for body weight reduction because the body weight is less likely to be reduced due to hormone secretion, and a period (hereinafter, referred to as “excellent period”) suitable for body weight reduction because the body weight is likely to be reduced.

Specifically, body weight reduction rhythm calculating unit 515 determines the menstrual period based on menstrual day information 704 of the user, and calculates an ovulation day based on the determined menstrual period in accordance with the Ogino method, for example. It should be noted that this may be calculated with reference to data of a basal body thermometer, for example.

Here, a luteal phase is calculated in which plenty of progesterone is secreted during a period of time from the ovulation day to the next menstruation start day. In the luteal phase, it is known that the body is likely to store water due to an influence of the progesterone. Hence, this period is determined as the “sluggish period” in which the body weight is less likely to be reduced. Meanwhile, a period during which plenty of estrogen is secreted after the end of menstruation until the ovulation day is calculated. Then, this period is determined as the “excellent” period.

As described above, based on menstrual day information 704, body weight reduction rhythm calculating unit 515 calculates, for each user, the “sluggish period” in which the body weight is less likely to be reduced, and the “excellent period” in which the body weight is likely to be reduced. Then, body weight reduction rhythm calculating unit 515 stores them in target information 800 of the user as body weight reduction rhythm 803.

Control unit 501 generates data of target achievement 804 and stores it in target information 800. The data of target achievement 804 includes data of reward calorie 805, a degree of achievement 806, integrated calorie consumption 807, and a group of achievement days 808 (see FIG. 8).

Specifically, control unit 501 updates the data of target achievement 804 whenever measured calorie consumption data 703 is newly registered in measurement information 700. Specifically, control unit 501 calculates a difference (the measured calorie consumption—the target calorie consumption) between calorie consumption indicated by measured calorie consumption data 703 and target calorie consumption 609 of personal information 600. When the difference has a positive value, the difference is added to reward calorie 805. When the difference has a negative value, the difference is subtracted from reward calorie 805. Accordingly, when calorie consumption dependent on an activity amount exceeds the target calorie consumption, reward calorie 805 is increased. Otherwise, reward calorie 805 is decreased.

Further, when the above-described difference has a positive value or a value of zero, control unit 501 determines that the calorie consumption dependent on the activity amount has achieved the target, and counts up degree of achievement 806 by +1. Hence, degree of achievement 806 represents the number of days for which the calorie consumption has achieved the target. Further, the date of each of the days in which it is determined that the achievement has been made is registered in group of achievement days 808. Hence, each date in group of achievement days 808 represents the date of a day in which the calorie consumption dependent on the activity amount has achieved the target.

Further, control unit 501 adds the calorie consumption indicated by measured calorie consumption data 703 to integrated calorie consumption 807. Thus, integrated calorie consumption 807 represents an integrated value of the total calorie consumptions measured on/after the body weight reduction start day.

Message generating unit 516 makes reference to message logic table 900, determines whether or not each of sets of conditions 901 registered is established, and read, from message logic table 900, message data for a set of conditions 901 determined to be established.

The following describes one exemplary determination with reference to a specific exemplary set of conditions 901 in FIG. 9. Message generating unit 516 first makes a determination as to condition 1 (whether or not today is the fourth day in a week). When it is determined that condition 1 is established, determinations as to condition 2 and subsequent conditions will be made. When it is determined that condition 1 is not established, a determination is made as to a set of conditions 901 registered at the next position in message logic table 900.

When it is determined that condition 1 is established, a determination is made as to condition 2 (whether today is the twelfth day, nineteenth day, or twenty-sixth day from the diet start day), a determination is made as to condition 3 (positional relation between the latest measured body weight and the target zone (whether or not the latest measured body weight is within the target zone, is above the upper limit value, or is below the lower limit value)), a determination is made as to condition 4 (whether today is in the excellent period, a pre-sluggish period, a post-sluggish period, or the like of body weight reduction rhythm 803), and determination is made as to condition 5 (degree of achievement in terms of the average value of measured calorie consumption data 703 in one week with respect to the target, the degree of achievement being based on a difference between the average value thereof and target calorie consumption 609). Based on the results of the determination as to these conditions 1 to 5 as well as corresponding message data, message information to be displayed is generated in accordance with a predetermined procedure.

Graph data generating unit 517 generates graph data for display. Specifically, based on measured body weight data 702 registered in measurement information 700, graph data generating unit 517 generates graph data to display, on display 205, a graph representing a time-series change in the measured body weight value according to the dates of measurement.

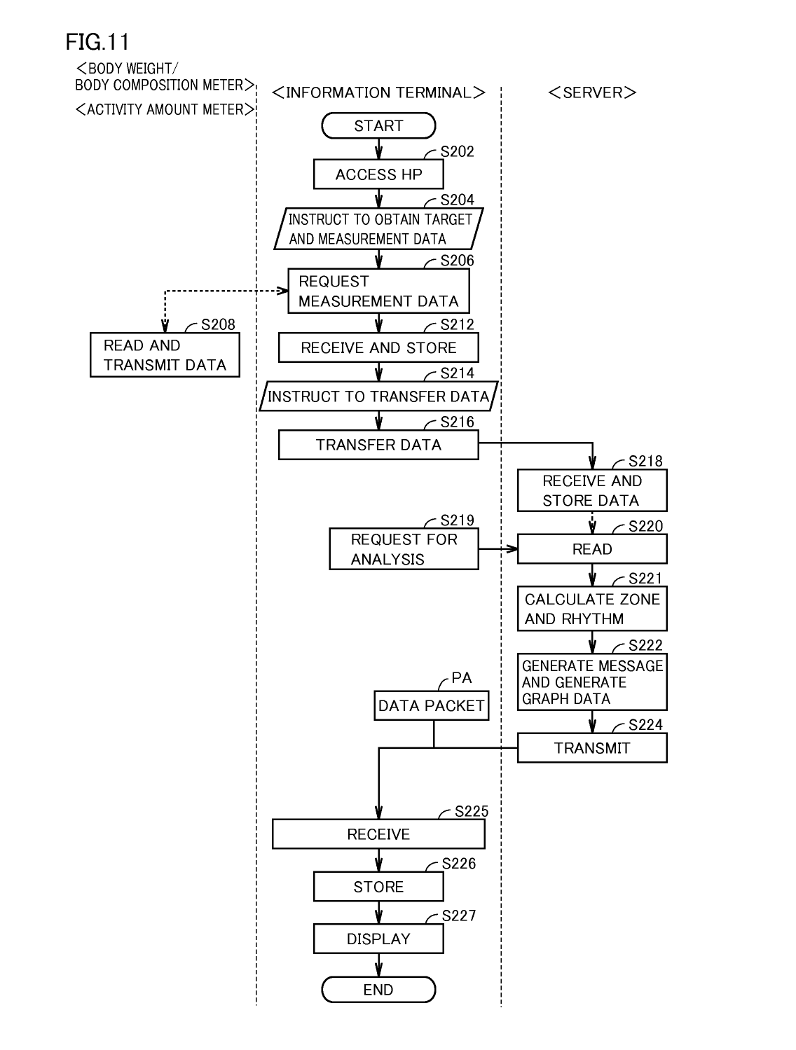

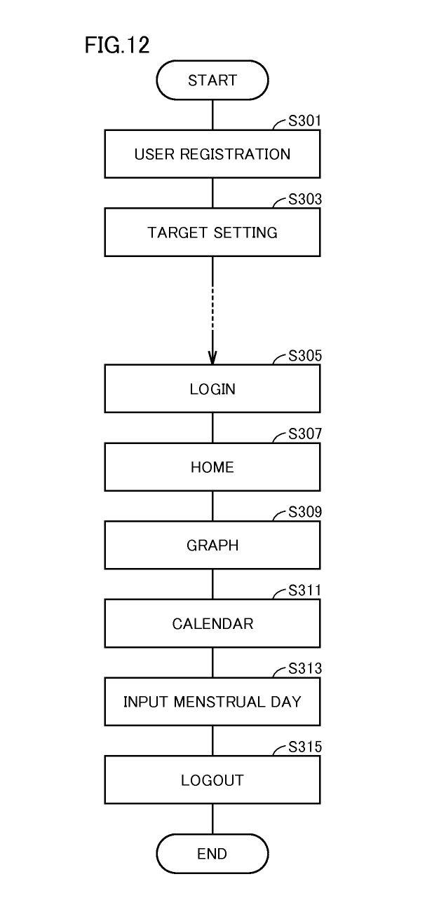

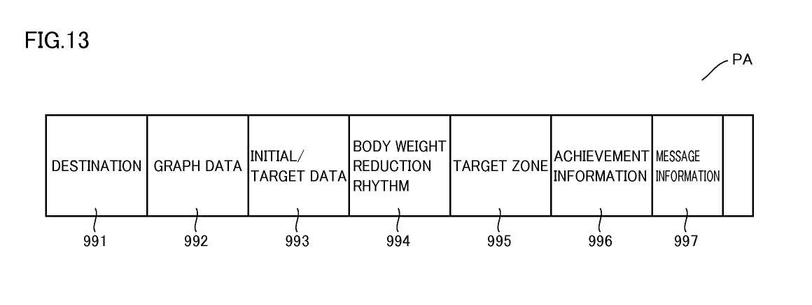

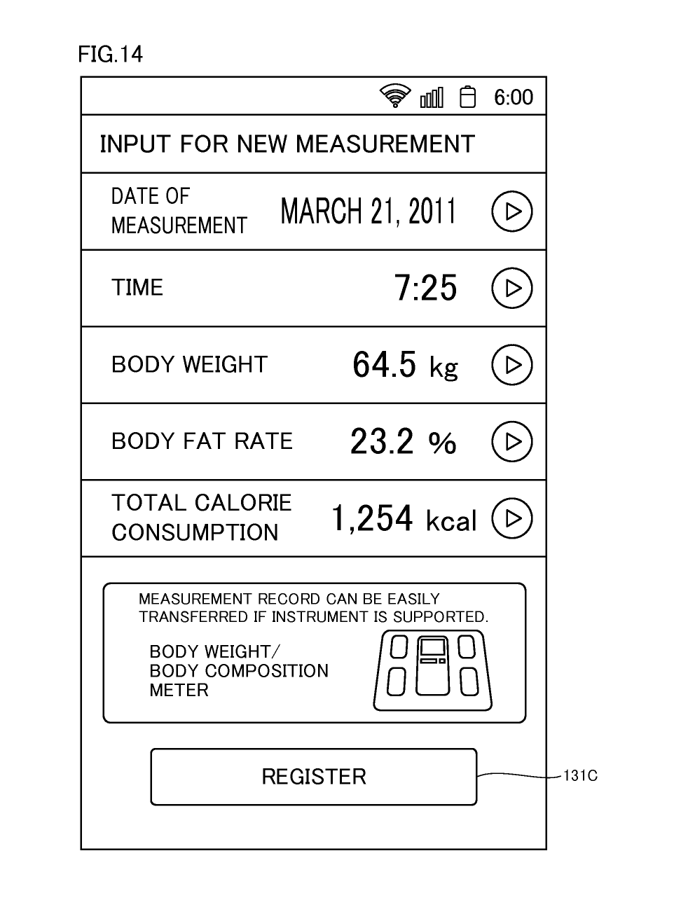

FIG. 11 and FIG. 12 show process flowcharts for the health management supporting system in the present preferred embodiment of the present invention. FIG. 11 shows a flow in which the measurement data is transmitted from body weight/body composition meter 34 or activity amount meter 33 to server device 1 via smart phone 23 or the information terminal, and a flow in which server device 1 processes the measurement data and transmits a result of the process to smart phone 23 to output it. FIG. 12 shows a process flowchart in which smart phone 23 outputs the information received from server device 1. FIG. 13 shows one exemplary communication data packet. FIG. 14 to FIG. 25 show exemplary screens displayed on the smart phone.

The following describes the data transmission flow. Referring to FIG. 11, based on an instruction from the user, smart phone 23 accesses a predetermined HP (homepage) provided by server device 1 (step S202). On this occasion, smart phone 23 displays a menu screen on display 205. As a program, the user selects the “diet function”, and inputs his/her name, address, age, sex, body height, initial body weight, and target body weight. These input data are transmitted to server device 1, and are stored in storage unit 502 by data storing unit 511 as personal information 600 shown in FIG. 6. In doing so, data storing unit 511 assigns generated ID 601 to personal information 600. Further, control unit 501 calculates a total calorie consumption/day to be attained, and registers this in personal information 600 as target calorie consumption 609.

Here, control unit 501 calculates target calorie consumption 609 by adding calorie consumption (referred to as “second calorie consumption”), which is calculated using target body weight 608, to calorie consumption (referred to as “first calorie consumption”) calculated in accordance with a known formula (normal body weight×basal metabolism reference value×physical activity level).

The normal body weight in the calculation formula for the first calorie consumption represents a body weight determined in accordance with a known procedure based on the data of age 604, sex 605, and body height 606 in personal information 600. Further, the physical activity level in this formula represents one of the following indexes: (Low: index of 1.5), (Normal: index of 1.75), and (High: 2.0). It is assumed that the physical activity level is input by the user in advance.

The second calorie consumption preferably is calculated by converting the difference between initial body weight 607 and target body weight 608 into a heat quantity. Here, it is known that a heat quantity of 7 kcal is consumed to burn 1 g of fat. Hence, in the present preferred embodiment, the second calorie consumption preferably is calculated in accordance with the following formula: ((the difference (g)×7 kcal)/the target achievement period (days)).

ID 601 assigned to registered personal information 600 is returned to smart phone 23. Control unit 232 of smart phone receives this, and stores it in a predetermined region of storage unit 239 as ID data 240 (see FIG. 4). Thereafter, when making communication with server device 1, smart phone 23 reads ID data 240 from the predetermined region, and transmits it to server device 1 as information by which server device 1 authenticates smart phone 23.

Thereafter, when the user operates touch panel 210 to input an instruction to obtain the measurement data (step S204), control unit 232 transmits a measurement data request to body weight/body composition meter 34 and activity amount meter 33 via communication I/F 207 in accordance with the instruction (step S206). When each of body weight/body composition meter 34 and activity amount meter 33 receives the request, body weight/body composition meter 34 and activity amount meter 33 read the measurement data (the morning body weight, the evening body weight, and the measurement date thereof, as well as the calorie consumption, and the measurement date thereof) stored in their internal memories, and transmit the measurement data to smart phone 23 (step S208).

Smart phone 23 receives the measurement data via input/output I/F 209, and temporarily stores it in flash memory 206 (step S212). Thereafter, when the user operates touch panel 210 to input an instruction to transfer the measurement data (step S214), smart phone 23 reads from flash memory 206 the measurement data received in step S212, and transfers the measurement data to server device 1 together with ID data 240 (step S216).

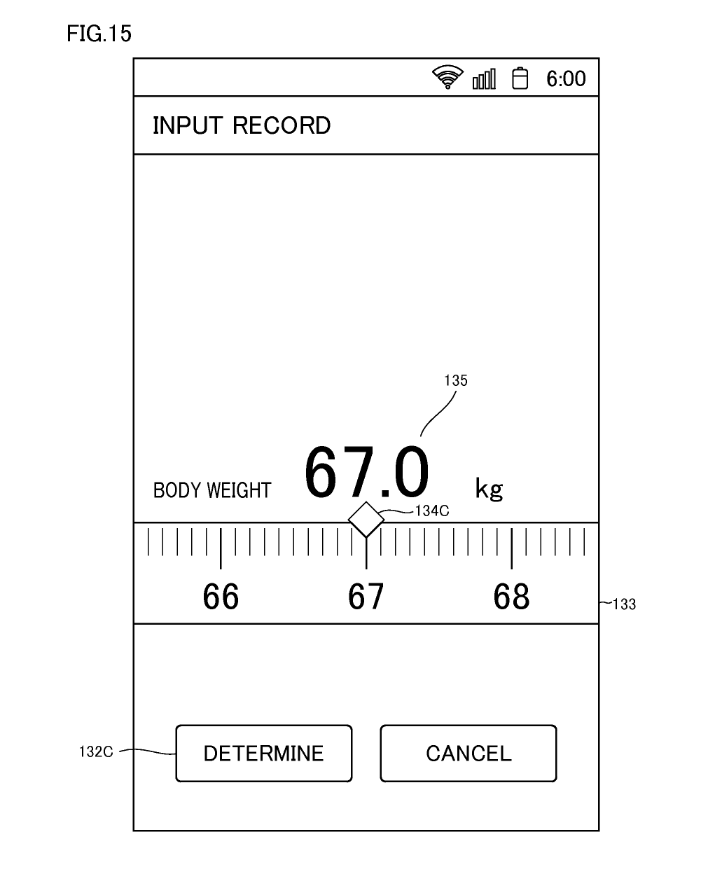

FIG. 14 and FIG. 15 show exemplary screens displayed to transfer the measurement data. The screen of display 205 in FIG. 14 displays a measurement date, a measured body weight, a measured body fat rate, and total calorie consumption, which are received from body weight/body composition meter 34 and activity amount meter 33. The user can operate an icon 131C to input an instruction to transfer the measurement data currently displayed.

It should be noted that the measurement data can be manually input by the user via the screen of FIG. 15, for example. The screen of FIG. 15 is a screen configured to receive input of a measured body weight, and a scale 133 is displayed therein by display control unit 233. Scale 133 can be slid, and is marked with numerical values. The user slides scale 133 to position the mark of a desired numerical value of scale 133 onto an icon 134C, which is fixedly displayed by display control unit 233 in relation to scale 133. The numerical value marked in scale 133 and aligned with the position of icon 134C is displayed as data 135. Hence, the value of data 135 is changed in conjunction with the sliding operation. In the case where the body weight value indicated by data 135 is input as the measured body weight, the user operates an icon 132C. When icon 132C is operated, control unit 133 inputs the value of data 135.

When the user performs the sliding operation, operation receiving unit 231 detects a slide amount (corresponding to, for example, an amount of movement of a finger on the screen (inclusive of a direction of movement)), and sends the detected slide amount to display control unit 233. Display control unit 233 updates the currently displayed marks of scale 133 in accordance with the slide amount. In this way, the user can readily input a desired numerical value by sliding scale 133 without switching between input modes for numerical values and letters/characters.

It has been illustrated that the data transfer from smart phone 23 to server device 1 is performed in accordance with the instruction of the user, but the method of transfer is not limited to this. For example, smart phone 23 may be configured to automatically transfer the measurement data to server device 1, when completing the reception of the measurement data from body weight/body composition meter 34 and activity amount meter 33.

It has been also illustrated that server device 1 receives the measurement data from body weight/body composition meter 34 and activity amount meter 33 via smart phone 23, but may be configured to receive the measurement data from body weight/body composition meter 34 and activity amount meter 33 not via smart phone 23.

When server device 1 receives the measurement data from smart phone 23 via communication unit 503, data storing unit 511 stores the received measurement data in storage unit 502 as measurement information 700. On this occasion, ID data 240 received together with the measurement data is registered in measurement information 700 as ID 701. It should be noted that in the case where measurement information 700 having ID 701 matching with ID data 240 has been already stored in storage unit 502, data storing unit 511 registers the received measurement data as measured body weight data 702 and measured calorie consumption data 703 of measurement information 700. On this occasion, when the user inputs menstrual days (start day, end day, and the like) via touch panel 210, information regarding this is also transmitted to server device 1 and data storing unit 511 stores this as menstrual day information 704 of measurement information 700 (step S218).

In this way, server device 1 collects the measurement data from body weight/body composition meter 34 and activity amount meter 33.

Further, in smart phone 23, the user operates touch panel 210 to input a request for analysis on “diet”. The input request is transmitted to server device 1 together with ID data 240 read from storage unit 239 (step S219).

When control unit 501 of server device 1 receives the request for analysis via communication unit 503, data extracting unit 512 searches, based on ID data 240 received together with the request, storage unit 502 for personal information 600, measurement information 700, and target information 800 having IDs 601, 701 and 801 matching with ID data 240, and reads the information from storage unit 502 (step S220).

Based on personal information 600, measurement information 700, and target information 800 thus read as a result of the search, zone calculating unit 513 and body weight reduction rhythm calculating unit 515 calculate target zone 802 and body weight reduction rhythm 803 based on the above-described procedure (step S221). Further, message generating unit 516 generates message information in accordance with the above-described procedure based on each set of conditions 901 of message logic table 900, and graph data generating unit 517 generates graph data in accordance with the above-described procedure based on read measurement information 700 (step S222).

Distribution information generating unit 519 generates a data packet PA of FIG. 13 for transmission of the generated data to smart phone 23, and transmits data packet PA to smart phone 23 having made the request (step S224).

Specifically, distribution information generating unit 519 stores address 603 of personal information 600 read in step S220, as destination information 991 of data packet PA, and stores initial body weight 607 and target body weight 608 as initial/target data 993. Further, as graph data 992, body weight reduction rhythm data 994, target zone data 995, and message information 997, distribution information generating unit 519 respectively stores the graph data, body weight reduction rhythm 803, target zone 802, and the message information generated in steps S221 and S222. Further, distribution information generating unit 519 stores the data of target achievement 804 as achievement information 996. In this way, data packet PA is generated.

In smart phone 23, receiving unit 230 receives data packet PA from server device 1 (step S225). In smart phone 23, received data packet PA is sent to control unit 232.

Control unit 232 stores the information of data packet PA in storage unit 239 (step S226). Display control unit 233 reads the information of data packet PA from storage unit 239, generates display data using the read information, and drives display 205 in accordance with the generated display data. Accordingly, an image according to the display data is displayed on display 205 (step S227). Examples of displaying will be described later in detail. Thereafter, the series of processes are ended.

FIG. 12 shows a process performed by smart phone 23. FIG. 13 to FIG. 25 show exemplary screens displayed on display 205 of smart phone 23.

Referring to FIG. 12, when the user wishes body weight management through “diet”, processes of user registration (step S301) and target setting (step S303) are performed. Accordingly, processes similar to those in step S202 and step S204 are performed.

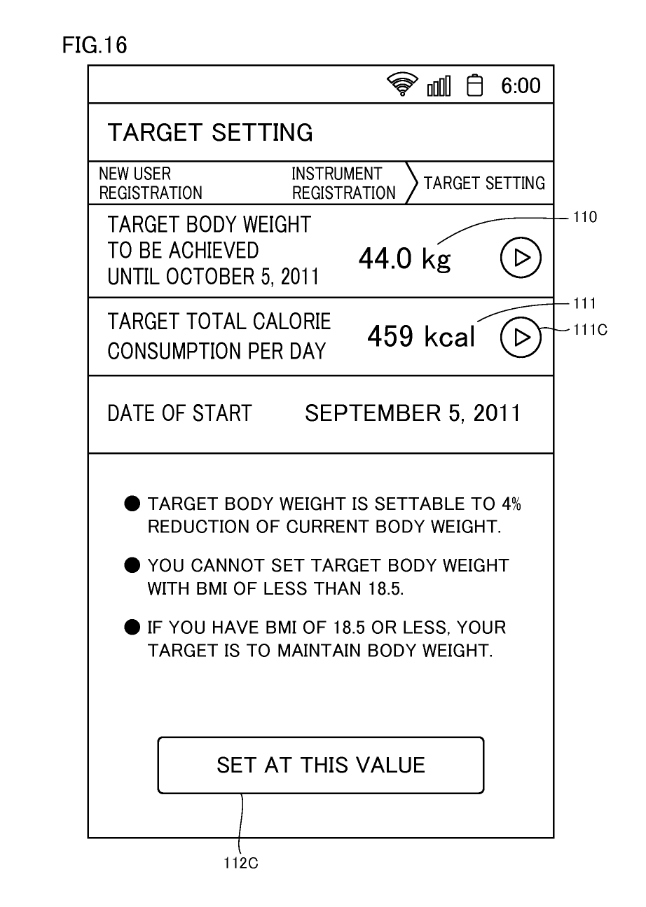

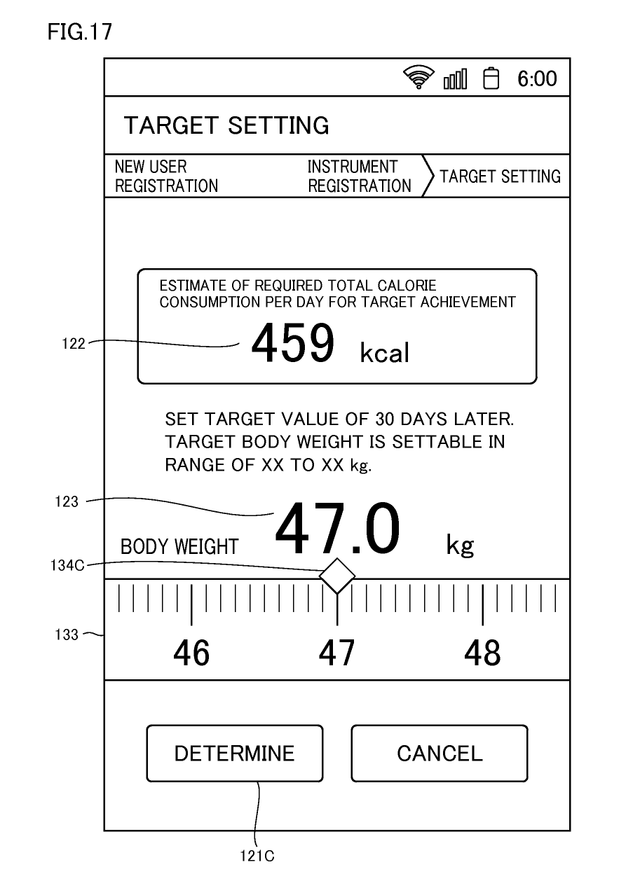

FIG. 16 and FIG. 17 show exemplary screens for setting a target body weight and target total calorie consumption. In FIG. 16, when the user inputs data 110 of target body weight, control unit 501 of server device 1 calculates target calorie consumption 609, and transmits it to smart phone 23 to display data 111 on display 205.

To change target calorie consumption 609, the user operates icon 111C. In accordance with the operation, the screen is switched to that of FIG. 17.

As described above, target calorie consumption 609 is determined by the target body weight, so that the user switches to the screen of FIG. 17 and resets data 123 of the target body weight. The target body weight thus reset is transmitted to server device 1. Server device 1 calculates target calorie consumption using the reset target body weight. The calculated target calorie consumption is transmitted from server device 1 to smart phone 23 to display it in the screen of FIG. 17. Accordingly, in the screen of FIG. 17, data 122 of the target calorie consumption is updated to the calculated value. Also in the screen of FIG. 17, scale 133, which can be operated by sliding, is displayed to input a target body weight. The user slides scale 133 to position the mark of a desired numerical value of scale 133 onto fixed icon 134C, which is displayed in relation to scale 133, thus inputting the desired numerical value as data 123 of the target body weight. In the case where the body weight value indicated by data 123 is determined as a target body weight, the user may operate icon 121C.

When icon 121C is operated, the screen is switched to the screen of FIG. 16. On the screen of FIG. 16 after the switching, the values of data 111 and 110 are updated using the target calorie consumption and the target body weight indicated by data 122 and 123, which have been changed in the screen of FIG. 17.

When the user wishes to determine, as a target for body weight management, the target body weight and the target calorie consumption indicated by data 110 and 111 displayed on the screen of FIG. 16, the user operates an icon 112C. In this way, the target body weight and the target calorie consumption indicated by data 110 and 111 are transmitted to server device 1 as target data, and are registered in personal information 600 as target body weight 608 and target calorie consumption 609.

When the user logs in from the predetermined homepage after setting the target (step S305), ID data 240 is read from storage unit 239 and a login request including read ID data 240 is transmitted to server device 1.

When server device 1 receives the login request via communication unit 503, data extracting unit 512 reads personal information 600, measurement information 700, and target information 800 of the user from storage unit 502 based on ID data 240 included in the login request. Distribution information generating unit 519 generates data packet PA using personal information 600, measurement information 700, and target information 800 thus read, and transmits it to smart phone 23 having made the request.

Receiving unit 230 of smart phone 23 receives data packet PA. Home screen display unit 235 generates display data based on the information of received data packet PA, and drives display 205 based on the generated display data. Accordingly, a home screen is displayed on display 205 (step S307).

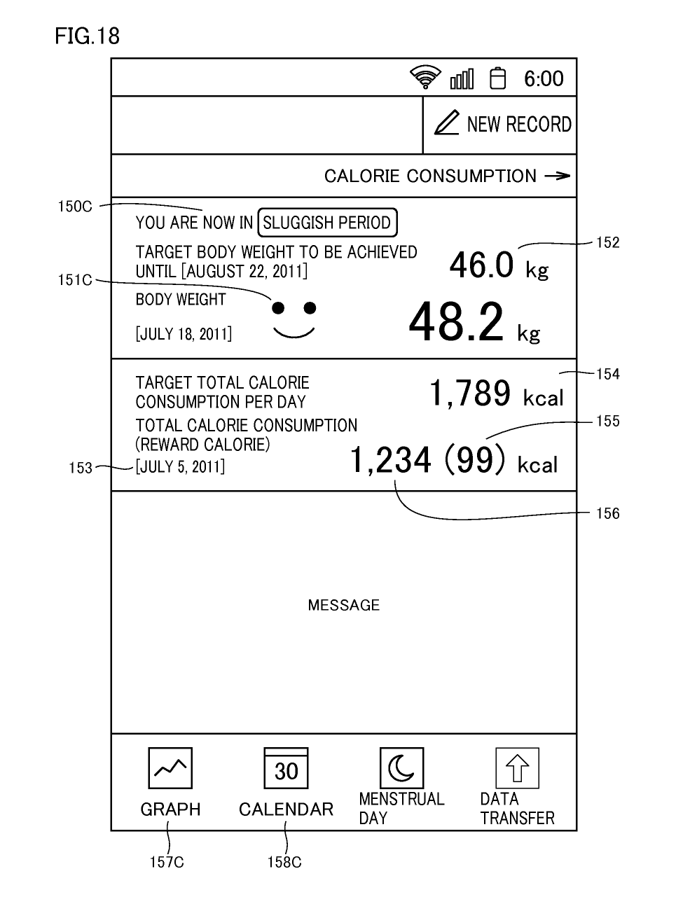

FIG. 18 shows one exemplary home screen. In the home screen of FIG. 18, information based on the latest measurement data is displayed. Displayed in the screen preferably are an icon 150C representing the “sluggish period” that is based on body weight reduction rhythm 803; and a morning/evening distinguishing icon 151C together with the latest measured body weight (48.2 kg) that is based on measured body weight data 702. Also displayed preferably are data 152 and 154 indicating target body weight 608 and target calorie consumption 609 of personal information 600; data 155 of the reward calorie that is based on the data of target achievement 804; and data 153 and 156 of the measurement date and measured value of the latest total calorie consumption that is based on measured calorie consumption data 703.

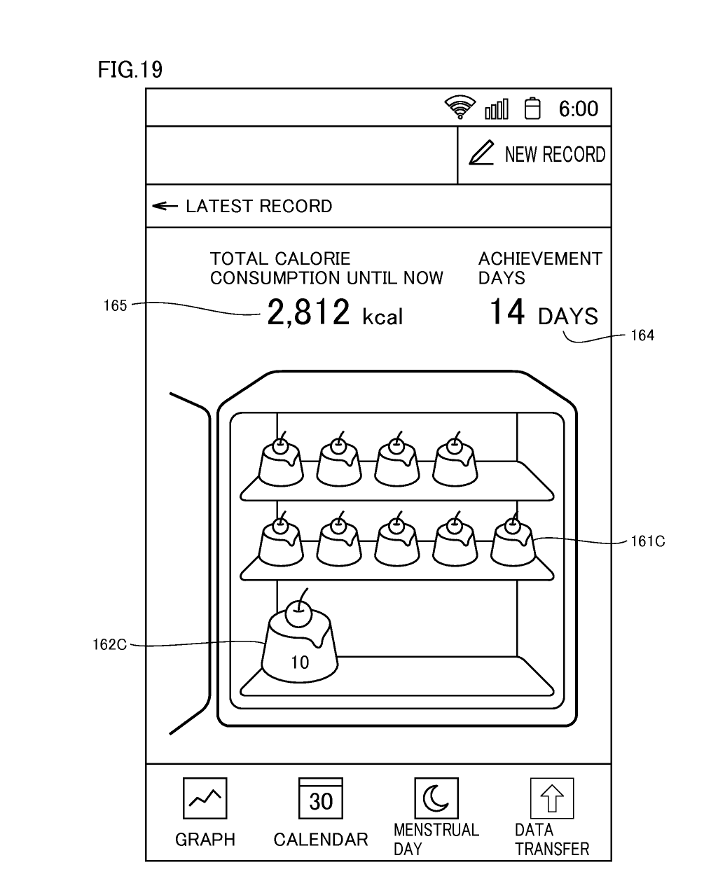

FIG. 19 shows a sub screen for the home screen of FIG. 18. Sub screen information in FIG. 19 is also generated based on the home screen information.

When the user flicks touch panel 210 while the home screen of FIG. 18 is being displayed, the display screen is switched from the screen of FIG. 18 to the screen of FIG. 19. When the user flicks while the screen of FIG. 19 is being displayed, the display screen is switched from the screen of FIG. 19 to the screen of FIG. 18. It should be noted that the term “flick” is intended to indicate an operation of slightly sliding a pen or finger in contact with the screen of display 205, but the type of the operation is not limited to this.

In FIG. 19, data 164 and 165 respectively indicate the number of days indicated by degree of achievement 806 of target achievement 804, and the value of integrated calorie consumption 507. Also displayed in the screen is an image of a refrigerator in which icons 161C and 162C representing puddings are arranged. The image is based on reward calorie 805 for target achievement 804. Each of icons 161C represents 1 kcal and icon 162C represents 10 kcal. Accordingly, the user recognizes as having reward calorie 805 as rewarded puddings, thus maintaining motivation for body weight reduction.

When icon 157C of the home screen of FIG. 18 is operated, a graph based on the measurement data is displayed (step S309).

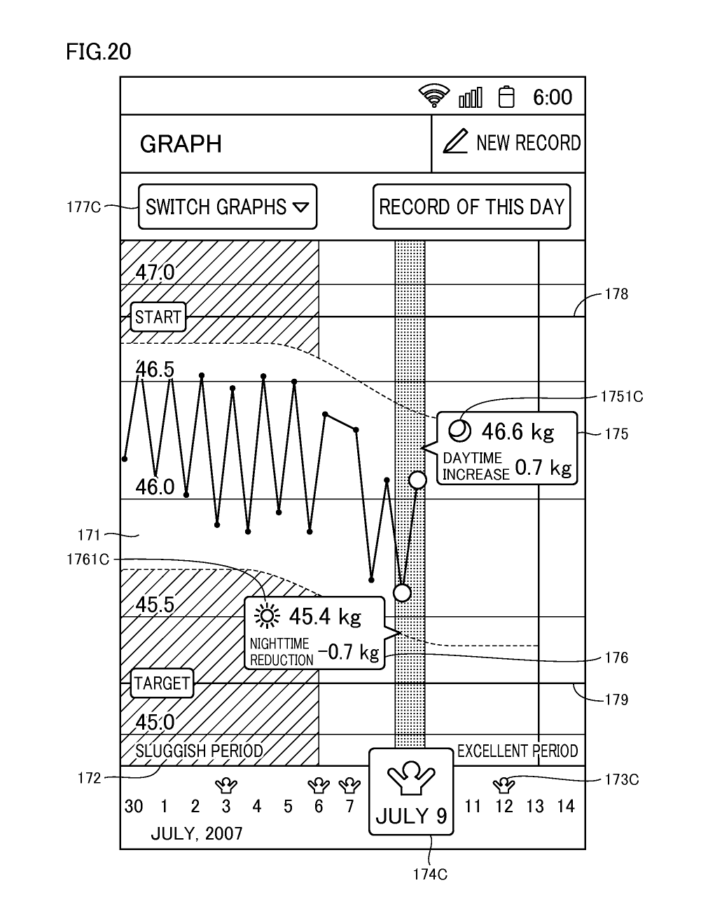

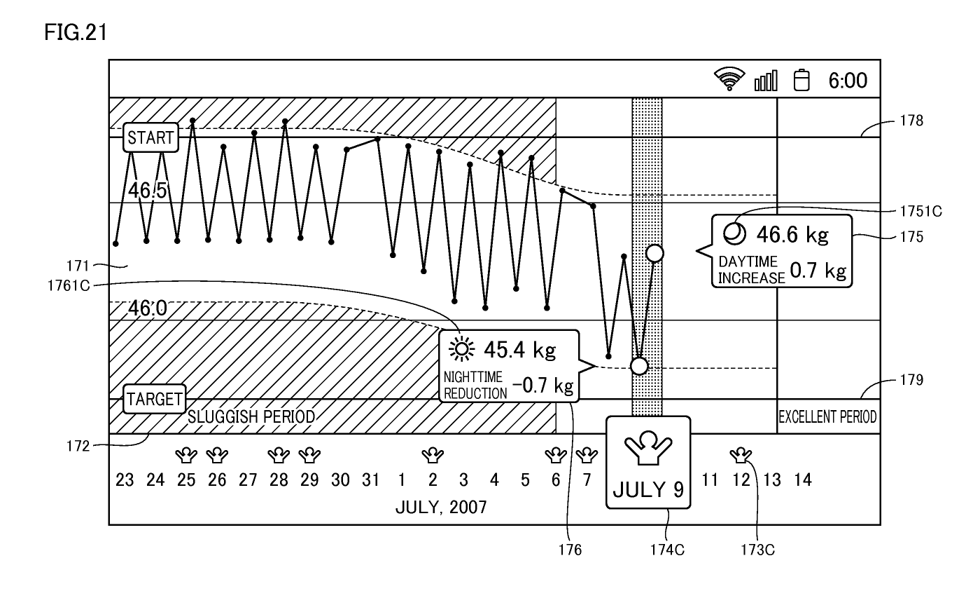

Specifically, graph display unit 236 generates graph data based on the information of received data packet PA, and drives display 205 based on the generated graph data. Examples of the display screen of the graph data are shown in FIG. 20 and FIG. 21.

The vertical axis of the displayed graph indicates the body weight value and the horizontal axis indicates the measurement date. The graph shows a line graph that is based on graph data 992 and that represents a time-series change in the measured body weight (morning body weight and evening body weight) according to the measurement dates thereof; and lines 178 and 179 representing initial body weight 607 and target body weight 608 that are based on initial/target data 993.

Further, in association with the measurement dates in the horizontal axis, the “sluggish period” and the “excellent period”, which are based on body weight reduction rhythm data 994, are displayed separately. Here, the “sluggish period” and the “excellent period” in the measurement period are displayed in different manners. In the figures, for example, the “sluggish period” is displayed in a color different from that of the “excellent period” as indicated by oblique lines 172. Further, icons 173C are displayed in association with dates indicated by group of achievement days 808 of achievement information 996 in the horizontal axis.

Further, an image of zone 171 is displayed based on target zone data 995. In FIG. 20, the graph representing the time-series change in the measured body weight and the image of zone 171 are displayed on the same screen. From the screen of FIG. 20, the user understands that the body weight is reducing according to the cases of body weight reduction having succeeded, because the time-series change in the measured body weight falls within target zone 802.

In the screen of FIG. 20, when the user operates touch panel 210 to designate a desired date, graph display unit 236 points out the designated date using an icon 174C, obtains the morning body weight and evening body weight on the day from graph data 992, and displays this information using dialog balloons 175 and 176. Dialog balloons 175 and 176 are displayed at positions that do not overlap with the graph. In dialog balloon 175, the evening body weight and an “evening” mark 1751C are displayed. In dialog balloon 176, the morning body weight and a “morning” mark 1761C are displayed. Further, in dialog balloon 175, a daytime increased value, which is a difference between the evening body weight and the morning body weight, is displayed. In dialog balloon 176, a value of nighttime reduced body weight is displayed.

Here, it has been illustrated that by designating the date, a portion of the line graph representing the measured body weights is designated and a measured body weight corresponding to the designated portion thereof is displayed, but when a portion of the graph is designated instead of designating a date, a measured body weight on a date corresponding to the portion may be displayed.

Further, in the present preferred embodiment, manners of displaying the graph can be switched. Specifically, the display region of display 205 preferably has a rectangular or substantially rectangular shape, so that if the vertical axis of the graph extends in the long-side direction, the horizontal axis extends in the short-side direction, with the result that the line graph that can be displayed represents a relatively short measurement period as shown in FIG. 20. To address this, in response to the user operating icon 177C on the screen of FIG. 20, switching unit 237 of graph display unit 236 switches the screen of FIG. 20 to a screen of FIG. 21. The screen of FIG. 21 is displayed such that the vertical axis of the graph of FIG. 20 extends in the short-side direction and the horizontal axis extends in the long-side direction. In this way, the graph for a longer measurement period than that in FIG. 20 preferably is displayed.

Here, it has been illustrated that whenever icon 177C is operated, the display screen is alternately switched between the screens of FIG. 20 and FIG. 21, but switching unit 237 may alternately switch between the screens of FIG. 20 and FIG. 21 by detecting a change in inclination of smart phone 23 (more particularly, display 205).

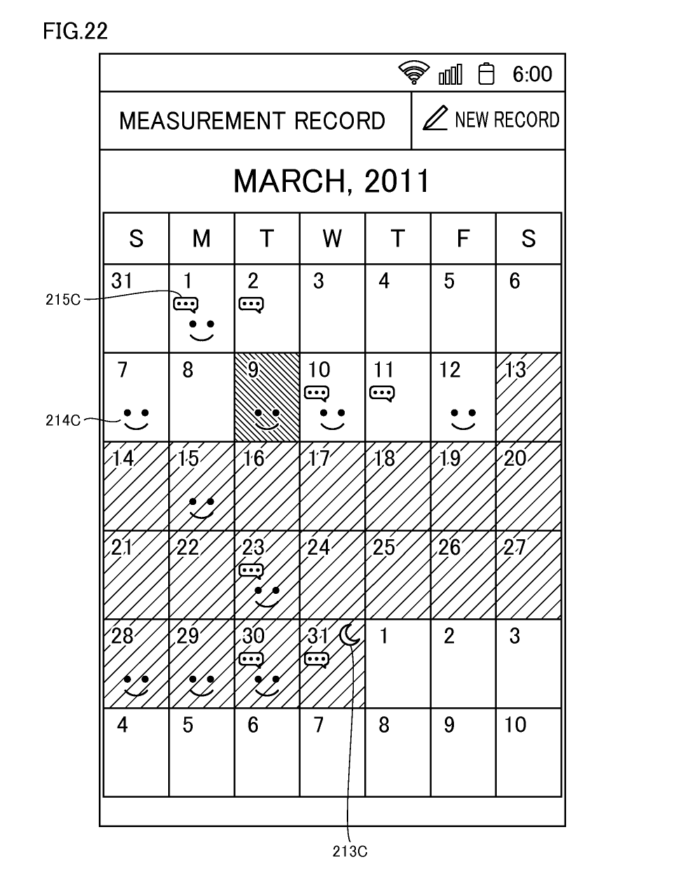

Now, the description herein is directed back to the home screen of FIG. 18. In response to icon 158C being operated in the screen of FIG. 18, calendar generating unit 518 generates calendar data based on the information of received data packet PA, and drives display 205 based on the generated calendar data. FIG. 22 shows one exemplary display screen of the calendar data. FIG. 22 shows a calendar that is based on the measurement data (step S311).

The calendar of FIG. 22 has boxes corresponding to one month. In each of the boxes, a date is displayed. Calendar generating unit 518 compares the measured body weight values for every morning and every evening with values in the target zone. When calendar generating unit 518 determines, based on the result of comparison, that the measured morning and evening body weight values indicate values falling within the target zone, an icon 214C is displayed on the box corresponding to the date. Further, an icon 213C is displayed in a box corresponding to the date of the menstruation start day. Further, in the calendar, the “sluggish period” and the “excellent period” are displayed in different manners. For example, a date in the “sluggish period” is displayed in a color different from that of a date in the “excellent period”.

Further, in the present preferred embodiment, the user's memo data preferably is registered so as to correspond to each date. In the calendar, an icon 215C preferably is displayed in a box corresponding to a date for which such memo data is registered.

It should be noted that unlike FIG. 22, the calendar may be displayed based on a week as a unit rather than a month as a unit. There is no limitation in this point.

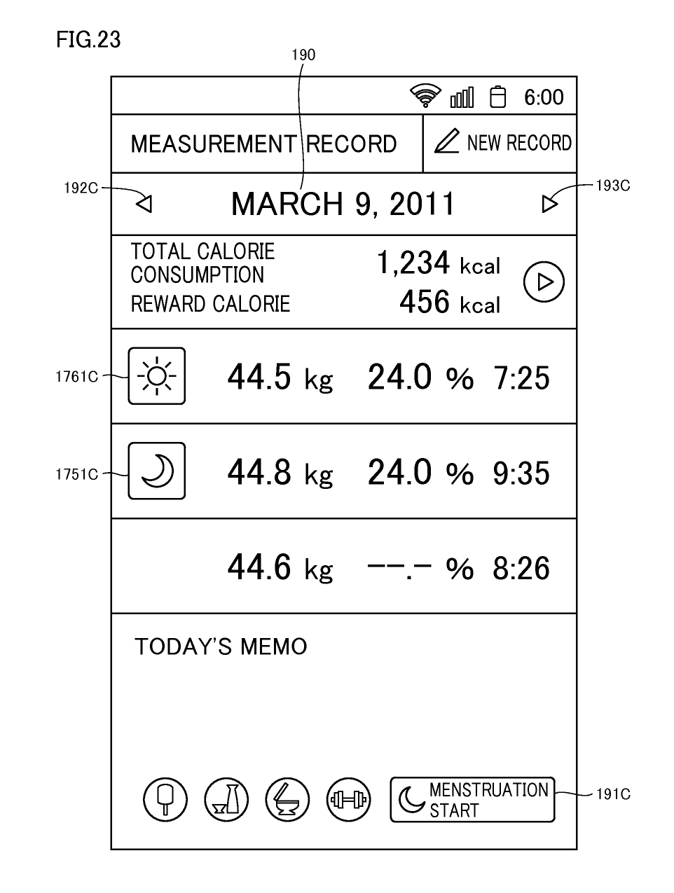

Here, when the user operates touch panel 210 to designate a desired date (for example, March 9 in FIG. 22) on the calendar, control unit 501 switches the screen to a screen of FIG. 23 to display measurement data recorded on the designated date.

In the screen of FIG. 23, the morning and evening body weights measured on the designated date (March 9) are displayed together with icons 1761C and 1751C. Further, by operating icon 192C or 193C in the screen, the date can be switched to the previous day or the next day, such that morning and evening body weights measured on the date to which the switching has been made are displayed.

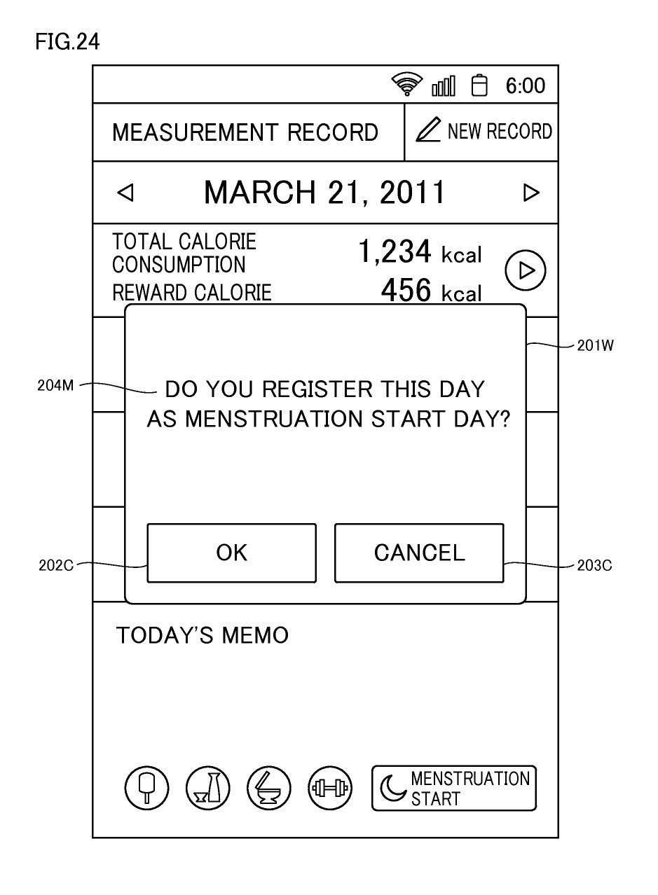

When the user operates an icon 191C via touch panel 210 in the screen of FIG. 23, control unit 501 switches the screen to a screen of FIG. 24 to input a menstrual day (step S313).

In the screen of FIG. 24, a window 201W is displayed over the screen of FIG. 23. In window 201W, an inquiry message 204M and icons 202C and 203C are displayed. Inquiry message 204M provides an inquiry as to whether to register, as a menstruation start day, the measurement date (March 9) indicated by data 190 in the screen of FIG. 23.

When the user operates icon 203C to instruct canceling, window 201W disappears and the screen of FIG. 23 is displayed. On the other hand, when icon 202C is operated to request registration of the menstruation start day, menstrual day accepting unit 234 accepts, as the menstruation start day, the measurement date indicated by data 190. It should be noted that although not shown in the figures, a menstruation end day can be accepted in a similar manner.

ID data 240 stored in storage unit 239 is added to the data of the accepted menstruation start day, and then the data is transmitted to server device 1. Communication unit 503 of server device 1 receives the data of the menstruation start day, and sends it to control unit 501. Data storing unit 511 of control unit 501 searches for measurement information 700 having ID 701 matching with ID data 240 received together with the data of the menstruation start day, and registers the received data of the menstruation start day in menstrual day information 704 of measurement information 700 searched for. In this way, the user can input the menstruation start day any time whenever she notices it. Hence, the latest body weight reduction rhythm may be always calculated by regularly calculating body weight reduction rhythms for the “sluggish period” and the “excellent period”.

Thereafter, the user logs out, thus ending the process of FIG. 12 (step S315).

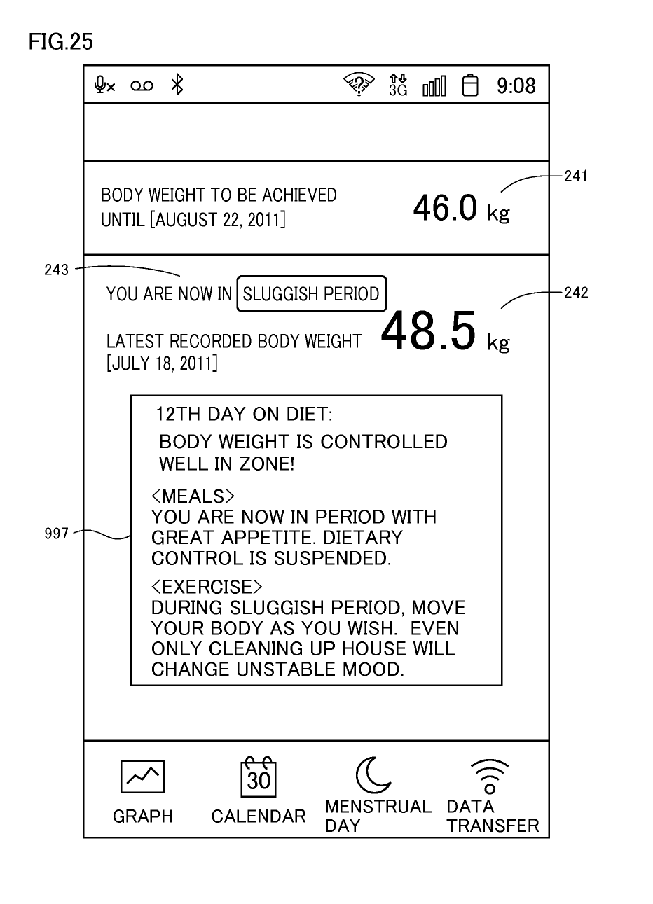

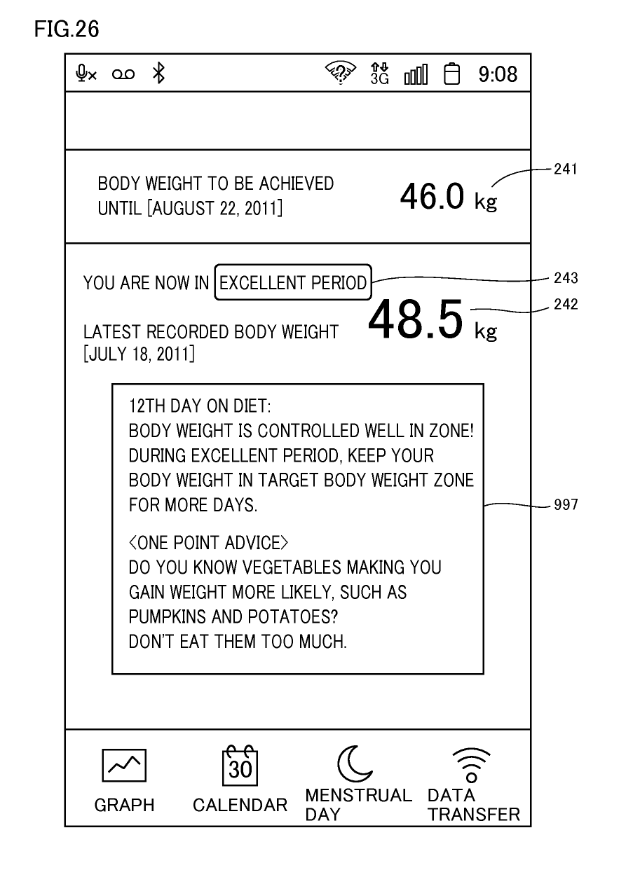

FIG. 25 and FIG. 26 show exemplary display screens of message information 997 provided by display control unit 233. In each of FIG. 25 and FIG. 26, measured body weight value 242, which has been recorded most recently, is displayed together with target body weight value 241 based on the information of received data packet PA. Also, information 243 is displayed which indicates that the present time corresponds to either the “sluggish period” or the “excellent period”. The screen of FIG. 25 or FIG. 26 separately displays the latest measurement data and the “sluggish period” or the “excellent period” to the user, and also presents message information 997 including an advice for body weight management based on this information. Accordingly, the user is more likely to maintain motivation for body weight reduction.

The present preferred embodiment has been described and illustrated assuming that the user measures a body weight “every morning and every evening”, but the functions by the present preferred embodiment can be applied also in the case where the user is a “person who measures a body weight only every morning”, a “person who measures a body weight only every evening”, a “person who measures a body weight only every afternoon”, or the like.

In addition, in the present preferred embodiment, the body weight management has been described and illustrated among the physical status information, but a management function similar to that for the body weight can be provided for a different type of physical status information.

### Other Preferred Embodiments

The above-described display control method for smart phone 23 can be also provided as a program, for example. Such a program can be recorded onto a computer readable storage medium such as a flexible disk, a CD-ROM (Compact Disc Read Only Memory), a ROM, a RAM, and a memory card attached to a computer in a non-transitory manner, and the storage medium can be provided as a program product. Alternatively, the program can be recorded onto a storage medium, such as a hard disk, provided in a computer, thus providing the program. The program can be provided by download via a network. For example, in the configuration of FIG. 3, smart phone 23 including CPU 201 and having a function of computer can be provided with the program via storage medium 410. CPU 201 reads the program from storage medium 410 via drive device 208 and executes the program. Further, the program may be downloaded from an external device via communication path 52. CPU 201 reads and executes the program downloaded and stored in RAM 203 or the like.

The program product thus provided is installed in a program storage unit such as RAM 203 and is read and executed by CPU 201. It should be noted that the program product includes the program itself and the storage medium having the program stored thereon in a non-transitory manner.

In the present preferred embodiment, by displaying zone 171 of FIG. 20, a range of target values for days is preferably presented, so that the user can readily check whether or not his/her body weight is changing within the zone of target zone data 995. Accordingly, the user is enabled and empowered to work on body weight reduction or body weight control over the long term, and is able to check the pace of body weight reduction such that the user is less likely to regain the body weight. For example, the body weight can be more readily adjusted on weekends, thus facilitating continued body weight control.

From the image, one can visually check that the measured body weight value falls below the lower limit value of zone 171, thus facilitating finding excessive body weight reduction. Also from the image, one can visually check that the measured body weight value becomes larger than the upper limit value of zone 171, thus facilitating finding body weight increase resulting from excessive eating or lack of exercise.

Further, message information 997 including the advice for body weight management is generated based on the set of conditions 901 as well as progress of body weight reduction for each user, a menstrual period, total calorie consumption dependent on an activity amount, and the like. Hence, message information 997 including an effective advice, caution, or the like for each user preferably is presented.

The preferred embodiments disclosed herein are illustrative and non-restrictive in all respects. The scope of the present invention is defined by the terms of the claims, rather than the preferred embodiments described above, and is intended to include any modifications within the scope and meaning equivalent to the terms of the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-11. (canceled)

12. A display control device configured to provide a display that supports body weight reduction for a user, the display control device comprising:
a receiver configured to receive measurement data and zone data, the measurement data including a measured physical status value of the user and a corresponding measurement date, the zone data representing an upper limit value and a lower limit value of a physical status value for target achievement of the body weight reduction; and
a display device configured to display an image including a graph and a zone image in a same screen in association with each other, the graph representing a time-series change in the measured physical status value based on the measurement data received, the zone image representing a time-series change in the upper limit value and lower limit value based on the zone data received; wherein
the zone data is generated based on the measured physical status value at a start of the body weight reduction, a target physical status value, and a predetermined calculation formula.

13. The display control device according to claim 12, wherein the predetermined calculation formula is determined using measurement data of a case of successfully changing the measured physical status value at the start of the body weight reduction into the target physical status value.

14. The display control device according to claim 12, further comprising an operation receiver configured to receive an operation from the user; wherein
when the operation receiver receives the operation designating a portion of the graph, the display device displays, in the same screen, the measured physical status value measured on a measurement date corresponding to the portion.

15. The display control device according to claim 12, wherein
the receiver is configured to receive body weight reduction rhythm information indicating a period suitable for the body weight reduction and a period unsuitable for the body weight reduction based on menstrual day information of the user; and
the display device displays, in association with the graph, information indicating the period suitable for the body weight reduction and the period unsuitable for the body weight reduction based on the body weight reduction rhythm information.

16. The display control device according to claim 12, wherein
the receiver is configured to receive calorie consumption information indicating a result of comparison between calorie consumption, which is based on an activity amount of the user during a period of measurement of the physical status value, and target calorie consumption for the target achievement; and
the display device is configured to display an image, which is based on the calorie consumption information.

17. The display control device according to claim 16, wherein the calorie consumption information includes an integrated amount of a difference between the calorie consumption that is based on the activity amount and the target calorie consumption for the target achievement.

18. The display control device according to claim 12, wherein the display device is configured to display data indicating whether or not the measured physical status value of the measurement data received falls within a range defined by the upper limit value and the lower limit value of the zone data on a measurement date corresponding to the measured physical status value, in association with the measurement date in a form of a calendar.

19. The display control device according to claim 12, wherein
the display device is configured to display a message generated in a predetermined procedure based on a plurality of conditions; and
the plurality of conditions include:
a result of comparison between calorie consumption, which is based on an activity amount of the user during a period of measurement of the physical status value, and target calorie consumption for the target achievement; and
data indicating whether or not the measured physical status value of the measurement data falls within a range defined by the upper limit value and the lower limit value of the zone data on a measurement date corresponding to the measured physical status value.

20. The display control device according to claim 12, further comprising an operation receiver configured to receive an operation from the user; wherein
the display device is configured to display a scale image and a fixed image, the scale image including marks representing numerical values, the fixed image indicating a mark on the scale image;
the operation receiver is configured to receive a sliding operation of sliding the marks of the scale image displayed; and
the display control device is configured to input a numerical value represented by a mark indicated by the fixed image among the marks slid by the sliding operation received.

21. A non-transitory computer-readable medium including a computer program for performing, when the computer program runs on a computer, a method of controlling display on a display device for supporting body weight reduction of a user, the method comprising the steps of:
receiving measurement data and zone data, the measurement data including a measured physical status value of the user and a corresponding measurement date, the zone data representing an upper limit value and a lower limit value of a physical status value for target achievement of the body weight reduction; and
displaying a graph and a zone image in a same screen in association with each other, the graph representing a time-series change in the measured physical status value based on the measurement data received, the zone image representing a time-series change in the upper limit value and lower limit value based on the zone data received; wherein
the zone data is generated based on a measured physical status value at a start of the body weight reduction, a target physical status value, and a predetermined calculation formula.
